(19) United States
(12) Patent Application Publication
(10) Pub. No.: US 2021/0220944 A1
(43) Pub. Date: Jul. 22, 2021

(54) METHOD FOR LASER-PROCESSING A SURFACE AND LASER PROCESSING SYSTEM

(71) Applicant: LASERAX INC., Québec (CA)

(72) Inventors: Michaël DALLAIRE, Quebec (CA); Alex FRASER, Québec (CA); Xavier PRUNEAU GODMAIRE, Saint-Lambert-de-Lauzon (CA)

(21) Appl. No.: 16/967,523

(22) PCT Filed: Feb. 8, 2019
(86) PCT No.: PCT/CA2019/050169

§ 371 Date: Aug. 5, 2020

Related U.S. Application Data
(60) Provisional application No. 62/628,389, filed on Feb. 9, 2018.

(51) Int. Cl. B23K 26/03; B23K 26/06

(52) U.S. Cl. CPC B23K 26/032; B23K 26/0604

(57) ABSTRACT

There is described a method for laser-processing a surface. The method generally includes: directing, from a first viewpoint, a laser processing beam towards said surface including providing a focal point of said laser processing beam at a focal point position, resulting in illuminating said surface with a spot, while imaging said spot on said surface from a second viewpoint different from the first viewpoint; determining spatial coordinates of said surface based on calibration data and a feature of said imaged spot; and laser-processing said surface based on said previously determined spatial coordinates of said surface.

### FIELD

The improvements generally relate to laser processing systems and more particularly to laser processing systems which involve imaging.

### BACKGROUND

Conventional techniques for laser-processing a surface exist. In one conventional technique, spatial coordinates of the surface to be laser-processed are first determined using an optical 3D imaging system. The optical 3D imaging system has a laser line projector and a camera which are spaced apart from one another, have different viewpoints, and are referenced to one another. In a second, subsequent step, the so-determined spatial coordinates of the surface to be laser-processed can be communicated to a laser processing system, which can be operated to laser-process the surface based on these spatial coordinates. In practice, the optical 3D imaging system and the laser processing system have respective light beams, respective reference systems for spatial coordinates, and are made to correspond to one another based on calibration.

Although conventional techniques for laser-processing a surface have been satisfactory to a certain degree, there remains room for improvement.

### SUMMARY

It was found that the spatial coordinates of the surface to be processed could be obtained by imaging a spot formed on the surface by a laser processing beam which is displaced with respect to the surface.

More specifically, by knowing the relative position and orientation of the laser processing system and of the camera, the spatial coordinates of the surface can be determined, e.g., by triangulation, based on the spot formed on the surface by the laser processing beam as imaged by the camera. As such, features of the imaged spot, at any point in time, can vary based on the position, orientation and/or shape of the surface to be processed. For instance, in embodiments where the laser processing beam is converging, the imaged spot may not necessarily correspond to a focal point of the laser processing beam. Accordingly, in such embodiments, the imaged spot may have a different dimension than a dimension of the focal point, which when imaged can then help in determining the spatial coordinates of the surface so-illuminated by the laser processing beam. Examples of such features include a center position, a specific shape, a dimension (e.g., diameter), an orientation, and the like.

Accordingly, the spatial coordinates of the surface can be determined by imaging a first pass of the spot formed on the surface by the laser processing beam, within a given tolerance. The tolerance may be affected by the features of the imaged spot. For instance, the tolerance can be limited if the center position of the spot can be determined. Alternately, since the dimension of the spot is indicative of the distance between the focal point and the surface, the absolute value of that distance can be measured based on the dimension of the spot, and the measured distance can be used to move the focal point of the laser processing beam onto the surface or within a certain limited distance therefrom, after properly determining the direction of the displacement of the focal point to be applied.

As can be understood, the laser processing beam can process the surface only when the focal point is within a predetermined distance from the surface, and when a sufficient intensity is reached. Using a laser processing beam having a moveable focal point can allow to move the focal point on the surface, based on the previously determined spatial coordinates of the surface to laser process the surface.

In accordance with one aspect, there is provided a method for laser-processing a surface, the method comprising: directing, from a first viewpoint, a laser processing beam towards said surface including providing a focal point of said laser processing beam at a focal point position, resulting in illuminating said surface with a spot, while imaging said spot on said surface from a second viewpoint different from the first viewpoint; determining spatial coordinates of said surface based on calibration data and a feature of said imaged spot; and laser-processing said surface based on said previously determined spatial coordinates of said surface.

In accordance with another aspect, there is provided a laser processing system comprising: a frame; a laser processing subsystem mounted to said frame and having a first viewpoint relative to a surface, the laser processing subsystem being adapted to direct a laser processing beam towards said surface and to provide a focal point of said laser processing beam at a focal point position, resulting in illuminating said surface with a spot; a camera mounted to said frame and having a second viewpoint different from said first viewpoint, the camera being adapted to, simultaneously to said illuminating, image said spot of said surface and to generate an image of said spot; a computer communicatively coupled to said laser processing subsystem and to said camera, said computer having a memory system having stored thereon instructions executable by a processor to: determine spatial coordinates of said surface based on calibration data and a feature of said imaged spot in said image; and instruct the laser processing subsystem to laser process said surface based on said previously determined spatial coordinates of said surface.

In accordance with another aspect, there is provided a method for determining spatial coordinates of a surface, the method comprising: directing, from a first view point, a laser processing beam towards said surface including providing a focal point of said laser processing beam at a focal point position, resulting in illuminating said surface with a spot, while imaging said spot on said surface from a second viewpoint different from the first viewpoint; and determining spatial coordinates of said surface based on calibration data and a feature of said imaged spot.

It will be understood that the expression “computer” as used herein is not to be interpreted in a limiting manner. It is rather used in a broad sense to generally refer to the combination of some form of one or more processing units and some form of memory system accessible by the processing unit(s). Similarly, the expression “controller” as used herein is not to be interpreted in a limiting manner but rather in a general sense of a device, or of a system having more than one device, performing the function(s) of controlling one or more device such as an electronic device for instance.

It will be understood that the various functions of a computer or of a controller can be performed by hardware or by a combination of both hardware and software. For example, hardware can include logic gates included as part of a silicon chip of the processor. Software can be in the form of data such as computer-readable instructions stored in the memory system. With respect to a computer, a controller, a processing unit, or a processor chip, the expression “configured to” relates to the presence of hardware or a combination of hardware and software which is operable to perform the associated functions.

Many further features and combinations thereof concerning the present improvements will appear to those skilled in the art following a reading of the instant disclosure.

### DESCRIPTION OF THE FIGURES

In the figures,

FIG. 1 is a side elevation view of an example of a laser processing system, shown with spaced apart surfaces S_{A}, S_{B} and S_{C}, in accordance with an embodiment;

FIG. 2 is an oblique view of the laser processing system of FIG. 1, showing a focal point of a laser processing beam being moved along a first focal point path, resulting in illuminating a surface with a moving spot, in accordance with an embodiment;

FIG. 2A is a front elevation view taken along line 2A-2A of FIG. 2;

FIG. 2B is an image of the moving spot of FIG. 2;

FIG. 3A is a front elevation view of the surface of FIG. 2 showing the movement of a focal point along a second focal point path, resulting in illuminating the surface with a moving spot;

FIG. 3B is an image of the moving spot of FIG. 3A;

FIG. 4A is a front elevation view of the surface of FIG. 2 showing the movement of a focal point along a third focal point path, resulting in illuminating the surface with a moving spot;

FIG. 4B is an image of the moving spot of FIG. 4A;

FIG. 5A is an oblique view of the laser processing system of FIG. 1, showing a focal point of a laser processing beam being moved along a focal point path mapping a surface, in accordance with an embodiment; and

FIG. 5B includes a plurality of superposed images of the moving spot of FIG. 5A, each image showing the moving spot of FIG. 5A for a respective portion of the focal point path.

### DETAILED DESCRIPTION

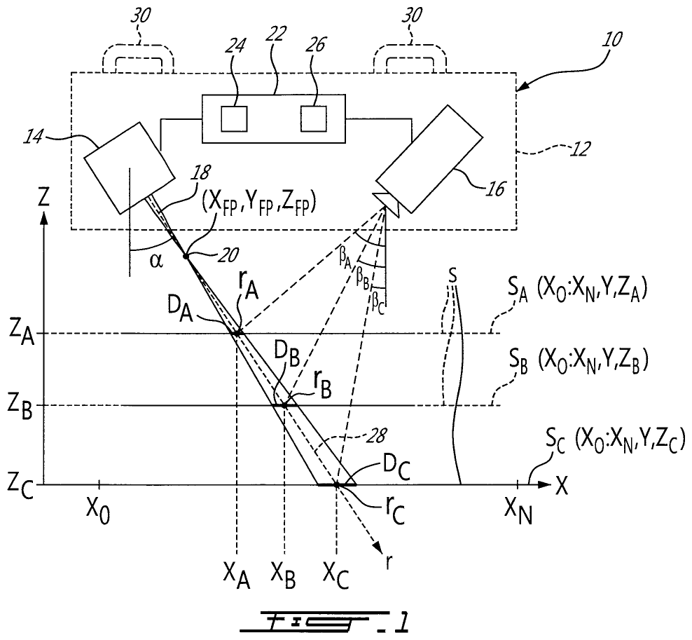

FIG. 1 shows an example of a laser processing system 10 for laser-processing a surface S, in accordance with an embodiment. The laser processing system 10 can be adapted to laser process the surface S in many ways. For instance, the laser processing system 10 can be used to laser clean the surface, to laser mark it, and/or to laser cut it depending on the embodiment.

As depicted, the laser processing system 10 has a frame 12, a laser processing subsystem 14 and a camera 16, both mounted to the frame 12.

The laser processing subsystem 14 and the camera 16 both have their own, respective, and different viewpoints relative to the surface S. Accordingly, the laser processing subsystem 14 has a first viewpoint, i.e., a known position and orientation in the X, Y, Z coordinate system, and the camera 16 has a different, second viewpoint, i.e., a known position and orientation in the X, Y, Z coordinate system.

As depicted, the laser processing subsystem 14 is adapted to direct a laser processing beam 18 towards the surface S, and to provide a focal point 20 of the laser processing beam 18 at a focal point position (X_{fp}, Y_{fp}, Z_{fp}) in the X, Y, Z coordinate system, which understandably results in the illumination of the surface S with a spot.

While the surface S is illuminated with the spot, the camera 16 is adapted to image the spot of the surface S and to generate an image of the spot, which can be referred to as “the imaged spot.” The camera can produce images of the surface S to be processed. In some embodiments, these images can have their own coordinate system X′ and Y′, and can be registered in the X, Y, Z coordinate system after their acquisition.

As shown, a computer 22 is communicatively coupled to the laser processing subsystem 14 and to the camera 16. In this example, the computer 22 is mounted to the frame 12 and is wiredly coupled to the laser processing subsystem 14 and to the camera 16. However, in some other embodiments, the computer 22 can be remote from the laser processing subsystem 14, and be wirelessly coupled thereto via wireless communication links such as Wi-Fi, Bluetooth, cellular data link and the like.

As can be understood, the computer 22 has a memory system 24 on which are stored instructions executable by processor(s) 26 to determine spatial coordinates of the surface S based on calibration data and on a feature (i.e., one or more features) of the imaged spot, and to instruct the laser processing subsystem 14 to laser process the surface S on the basis of the previously determined spatial coordinates of the surface S.

The calibration data allows to determine the spatial coordinates of the surface S based on the first viewpoint of the laser processing subsystem 14 and on the second viewpoint of the camera 16 as function of the feature(s) of the imaged spot.

Non-limiting examples of such calibration data are described in the following paragraphs for explanatory purposes.

Referring to FIG. 1, potential surfaces S_{A}, S_{B} and S_{C} have different spatial coordinates. In this example, the surfaces S_{A}, S_{B} and S_{C} have X coordinates extending from X₀ to X_{N}. However, the surface S_{A} has a Z coordinate corresponding to Z_{A}, the surface S_{B} has a Z coordinate corresponding to Z_{B}, and the surface S_{C} has a Z coordinate corresponding to Z_{C}, where Z_{A}>Z_{B}>Z_{C}.

As can be seen, in one specific embodiment, the spatial coordinates of the surface S_{A}, S_{B} or S_{C} can be determined based on a feature provided in the form of a center position of the imaged spot in the X, Y, Z coordinate system. Indeed, in this example, for a given orientation a of the laser processing beam 18, the calibration data can be indicative of the spatial coordinates X and Z as function of the coordinates X′ and Y′ (in pixels) of the center of the spot in the image generated by the camera 16 for an angle of incidence β. For instance, Table 1 shows an example of calibration data, provided in the form of a lookup table.

TABLE 1
Example of calibration data, provided in the form of a lookup table,
given a known viewpoint of the laser processing subsystem 14 and
a known viewpoint of the camera 16.

| β | X′ | Y′ | X | Z |
|---|---|---|---|---|
| [°] | [px] | [px] | [m] | [m] |
| β_{A} | X′_{A} | Y′_{A} | X_{A} | Z_{A} |
| β_{B} | X′_{B} | Y′_{B} | X_{B} | Z_{B} |
| β_{C} | X′_{C} | Y′_{C} | X_{C} | Z_{C} = 0 |

In the case of the surface S_{A}, the imaged spot can be determined to be incident on the camera 16 at an angle β_{A} and its center is localized at position X′_{A} and Y′_{A} in the image obtained by the camera 16. Accordingly, it can be determined that the spatial coordinates of the surface S_{A} are X_{A}, Y, Z_{A} based on the above calibration data. Similarly, in the case of the surface S_{B}, the imaged spot can be determined to be incident at an angle β_{B} on the camera 16 and its center is positioned at X′_{B} and Y′_{B} in the image. Accordingly, it can be determined that the spatial coordinates of the surface S_{B} are X_{B}, Y, Z_{B}.

Calibration data similar to those presented in Table 1 can be provided for other combinations of viewpoints of the laser processing subsystem 14 and of the camera 16. Accordingly, the right calibration data can be selected based on the first viewpoint of the laser processing subsystem 14 and of the second viewpoint of the camera 16 prior to actually determining the spatial coordinates of the surface S_{A}, S_{B} or S_{C}. As can be understood, the viewpoint of the laser processing subsystem 14 corresponds to a laser emission angle of the laser processing subsystem 14.

As can be seen, in another specific embodiment, the spatial coordinates of the surface S_{A}, S_{B} or S_{C} can be determined based on a feature provided in the form of a dimension D of the imaged spot in the X, Y, Z coordinate system. More specifically, the dimension D of the imaged spot corresponds to a diameter of the imaged spot in this example.

Indeed, in this specific example, for a given orientation a of the laser processing beam 18 and for a given convergence/divergence D(r) of the laser processing beam 18, where r is an axial position along an optical axis 28 of the laser processing beam 18, the calibration data can be indicative of the spatial coordinates X and Z as function of the dimension of the spot in the image generated by the camera 16.

As can be understood, due to the nature of converging beams, the laser processing beam 18 converges towards the focal point 20, but after the focal point 20 is reached, the laser processing beam 18 diverges. Accordingly, the spatial coordinates of the surface S_{A}, S_{B} or S_{C} can be determined on the basis of the dimension of the imaged spot. More specifically, as shown in FIG. 1, the surface S_{A} is positioned shortly after the focal point 20 of the laser processing beam 18, therefore the imaged spot has a diameter D_{A} which is greater than a diameter D_{fp} of the focal point 20. Similarly, the surface S_{B} is positioned after the focal point 20 of the laser processing beam 18, and even farther than the S_{A}. In this case, the imaged spot has a diameter D_{B} which is greater than the diameter D_{A} and greater than the diameter D_{fp} of the focal point 20. For instance, Table 2 shows an example of calibration data, again provided in the form of a lookup table.

TABLE 2
Example of calibration data, provided in the form of a lookup table,
given a known viewpoint of the laser processing subsystem 14 and
a convergence/divergence D(r) of the laser processing beam 18.

| D | X | Z |
|---|---|---|
| [m] | [m] | [m] |
| D_{fp} | X_{fp} | Z_{fp} |
| D_{A} > D_{fp} | X_{A} | Z_{A} |
| D_{B} > D_{A} | X_{B} | Z_{B} |
| D_{C} > D_{B} | X_{C} | Z_{C} = 0 |

In some embodiments, the angle β of the spot in the image generated by the camera 16 can be used to determine on which side of the focal point 20 the surface S_{A}, S_{B} or S_{C} actually lies.

As can be understood from the example above, the spatial coordinates of the surface S_{A}, S_{B} or S_{C} can be determined based on a feature of the imaged spot. Examples of such features include a center position, a specific shape, a dimension (e.g., diameter), an orientation, and/or any suitable combination thereof.

In another embodiment, the images produced by the camera 16 can be pre-processed to correct the distortions induced by the viewpoint of the camera 16 upon the surface S. In such embodiment, the coordinate system X′ and Y′ of the image can be corrected to correspond to the coordinate system of the laser (X, Z) through a relationship such as one pixel of the camera 16 corresponds to one millimeter for the laser spot at the surface S in the X direction. In another specific embodiment, a mathematical relationship can be established to link the direction Y′ of the image to the Z direction of the laser processing subsystem 14, which also corresponds to the position Z of the surface S, in place of a calibration data set such as those described with reference to Table 1 and Table 2.

Moreover, in this example, the frame 12 has one or more handles 30 protruding or recessing from the frame 12 for handling purposes. More specifically, the laser processing system 10 is portable and handleable by a user in a manner which can allow a user to manually position the laser processing system 10 proximate to a surface S to laser process it as desired.

In some embodiments, a display can be mounted to the frame 12, and facing the user, for displaying user instructions to the user. An example of such user instructions includes instructing the user to move the laser processing system 10 closer or farther to the surface S when it is determined that the laser processing system 10 is too close to or too far from the surface S.

In this example, the laser processing beam 18 has a wavelength in an infrared region of the electromagnetic spectrum, e.g., 1064 nm, and so the camera 16 is configured to image illumination in that infrared region of the electromagnetic spectrum. Accordingly, the camera 16 used in this example is sensitive but not necessarily limited to the infrared region of the electromagnetic spectrum.

As can be understood, the camera 16 can be a 2D camera in some embodiments whereas the camera 16 can be a 3D camera in some other embodiments. Characteristics of the camera 16 such as sensor size, quantum efficiency, number of frame per seconds, aperture size, focal length of the lens of the camera and any other characteristics may have an impact on the calibration data. The system performance and can be tailored to suit specific industry needs. It is intended that although the illustrated embodiment has only one camera 16, other embodiments of the laser processing system 10 can have a plurality of cameras each having different, respective viewpoints with respect to the surface S to image. In these embodiments, an image of the spot moving on the surface S may stem from images acquired by one or more of the cameras.

In one specific embodiment, the laser processing subsystem 14 comprise a fiber-baser laser source. In some other embodiments, the laser processing subsystem 14 can also be a solid-state laser source or any other type of laser source.

Moreover, the laser processing subsystem 14 can include a 3-axis scanner, composed of two rotating mirrors and a moving lens, to direct the light toward the surface to be laser-processed. In another embodiment, the laser processing subsystem 14 can include a 2-axis scanner, composed of one rotating mirror and a moving lens, to direct the light toward the surface to be laser-processed. In still another embodiment, the scanner could be based on reflective optical parts, such as flat mirrors, converging mirrors and diverging mirrors, in any combination.

In still further embodiments, the laser processing subsystem 14 can have a scanning head with a fixed focal length. In these embodiments, the scanning head can be moved closer or farther from the surface S so that the focal point 20 of the laser processing beam 18 moves accordingly. In alternate embodiments, the surface S can be moved relative to the laser processing subsystem 14 in order to move the focal point 20 of the laser processing beam 18 relative to the surface S.

Depending on the embodiment, parameters of the laser processing beam 18 can be modified over time. For instance, in some embodiments, the laser processing subsystem 14 can be configured to modify a width, an optical power, a repetition frequency, a scanning speed, and any other suitable parameter, during a single pass of the laser processing beam 18 on the surface S to laser-process.

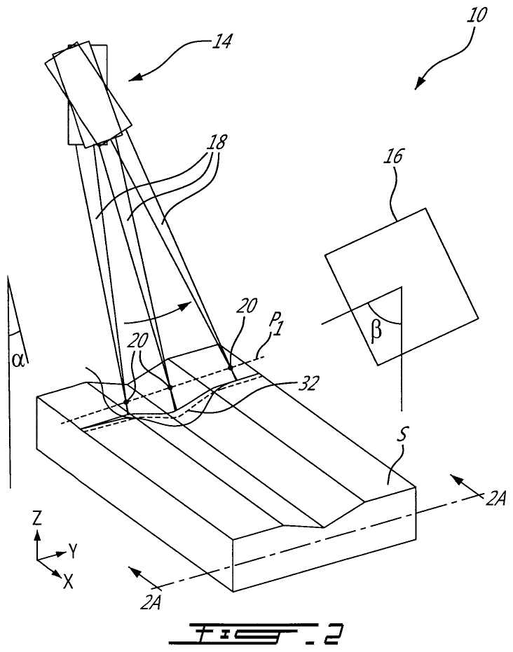

FIG. 2 shows an oblique view of the laser processing system 10 having the laser processing subsystem 14 and the camera 16, in accordance with another embodiment. As depicted, the laser processing beam 18 is directed towards a surface S and the focal point 20 of the laser processing beam 18 is moved along a first focal point path P1, resulting in illumination of the surface S with a moving spot 32. As can be understood, the camera 16 images the spot 32 as it moves on the surface S, and the spatial coordinates of the surface S are determined based on the features of the imaged moving spot.

FIG. 2A shows a front elevation view taken along line 2A-2A of FIG. 2, where it can be seen that the first focal point path P₁ does not correspond to the surface S. More specifically, the focal point 20 is moved in a direction 34 of movement, along the first focal point path P₁, which is above the surface S in this example. In some embodiments, the first focal point path P₁ is predetermined as it can be stored on the memory system of the computer 22, and updated thereafter based on the features of the imaged moving spot. The focal point path P₁ can be referred to as initial spatial coordinates of the surface S in some embodiments.

FIG. 2B shows an image 36 of the moving spot 32 as generated by the camera 16. As illustrated, the image 36 was acquired during an acquisition time of the camera 16 which was greater than a period of time required for the spot to move across the surface S. Accordingly, the image 36 shows a moving spot 32′ having the shape of a streak extending along the direction 34 of movement of the spot and having a varying dimension e.g., a varying thickness t.

In alternate embodiments, the imaged moving spot 32′ shown in FIG. 2B can be obtained from a plurality of images, each acquired during an acquisition time of the camera 16 which can be smaller than the period of time required for the spot to move across the surface S. In these embodiments, the spatial coordinates of portions of the surface S can be determined on the go. The spatial coordinates of the portions of the surface S can be updated in the memory system of the computer 22 as soon as they are determined in some embodiments. After such an update, the initial spatial coordinates of the surface S can become updated, or current spatial coordinates of the surface S.

In this specific example, the image 36 is in greyscale. Pixels of the image 36 are considered to be part of the imaged moving spot 32′ when they have an intensity greater than a predetermined threshold (e.g., intensity greater than 50, when greyscale spans from 0 to 256).

Due to the known position and orientation of the laser processing subsystem 14 and of the camera 16, the spatial coordinates of the surface S can be determined based on a center path 38 of the imaged moving spot 32′ and/or on a thickness t of the imaged moving spot 32′, the thickness t being measured perpendicularly to the center path 38. For instance, in this embodiment, it can be determined that the thickness t of the imaged moving spot 32′, throughout its length, exceeds a thickness threshold tₜₕᵣₑₛ, i.e., t>tₜₕᵣₑₛ. For instance, a properly focused beam could have a thickness of 3 pixels on the image, measured at half-maximum of the intensity in greyscale, such that tₜₕᵣₑₛ can be 4 pixels. Accordingly, the first focal point path P₁ can be determined to be too far from the surface S, and can be made closer in a subsequent, second pass of the focal point 20.

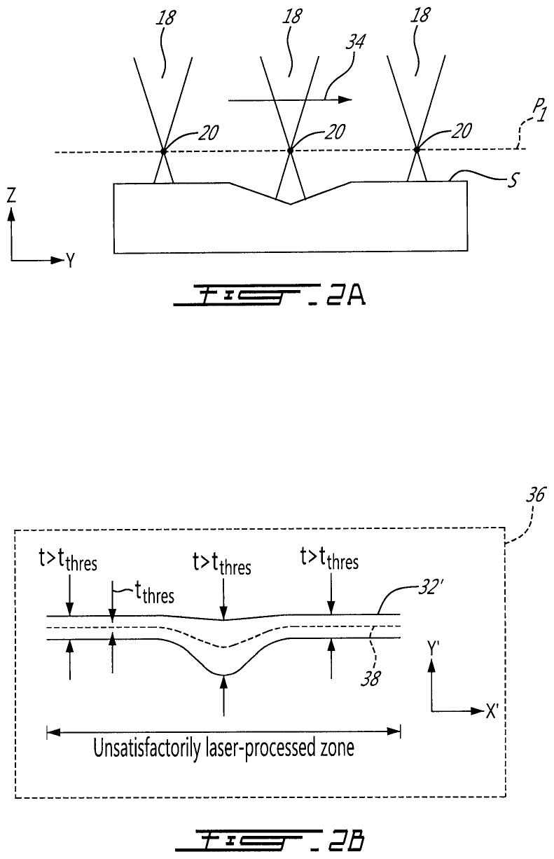

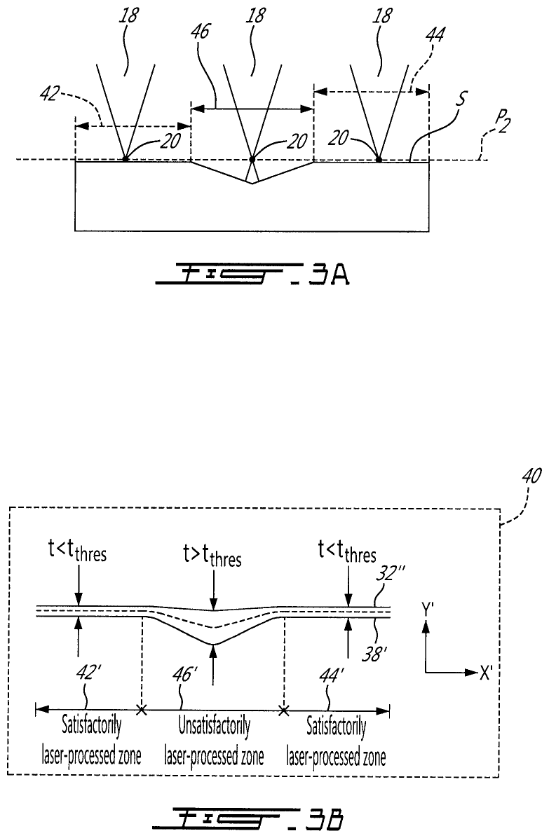

FIG. 3A is another front elevation view of the surface S, showing a second focal point path P₂ moved closer to the surface S based on the previously imaged moving spot. As it can be seen, the second focal point path P₂ has two spaced apart portions 42 and 44 which correspond to the surface S, between which a middle portion 46 is spaced from the surface S.

FIG. 3B shows an image 40 of the moving spot as it is moved along the second focal point path P₂. As can be seen, the thickness t in the spaced apart portions 42′ and 44′ of the imaged moving spot is below the thickness threshold tₜₕᵣₑₛ, which can confirm that the focal point 20 has been moved on the surface S in the spaced apart portions 42 and 44, within a given tolerance. An example of a tolerance can be 6 mm in some embodiments. However, the thickness t of a middle portion 46 of imaged moving spot is still greater than the thickness threshold tₜₕᵣₑₛ. Accordingly, the second point path P₂ can be determined to be still too far from the surface S in the middle portion 46 and it can be determined that the focal point 20 should be moved even closer to the surface S in that portion of the second focal point path P₂, in a subsequent, third pass of the focal point 20. Furthermore, the spatial coordinates of the surface S can be determined based on a center path 38′ of the imaged moving spot 32″, and used to further adjust the second point path P₂ to match the surface irregularities.

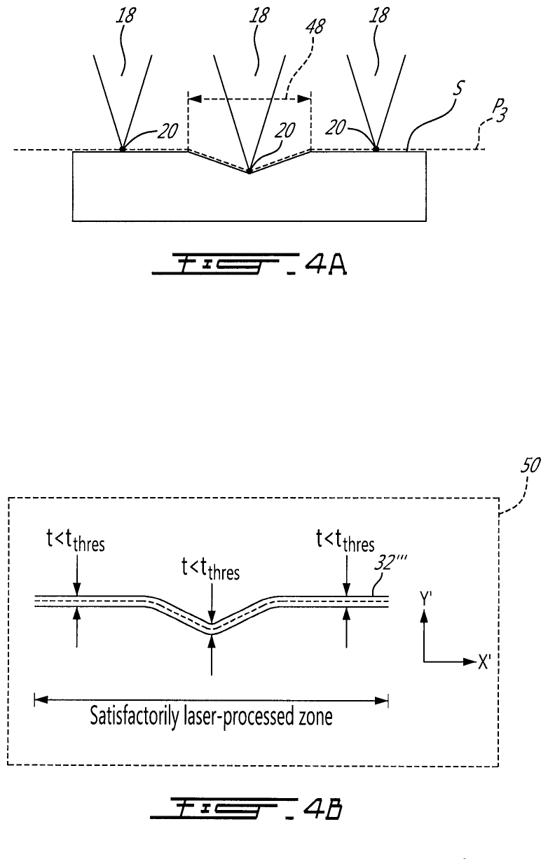

FIG. 4A is another front elevation view of the surface S, showing a third focal point path P₃ moved closer to the surface S based on the previously iterations of the method. As it can be seen, the third focal point path P₃ has the two spaced apart portions 42 and 44 which have been previously determined to correspond to the surface S. However, the third focal point path P₃ has a different middle portion 48 which has been modified to correspond to the surface S. In this embodiment, imaging the focal point 20 as it is moved along the third focal point path P₃ to provide the moving spot 32′″ can result in image 50 shown in FIG. 4B. As depicted, the thickness t of the imaged moving spot 32′″ in the image 50 is smaller than the thickness threshold tₜₕᵣₑₛ along its length. Accordingly, in this case, the spatial coordinates of the surface S can be determined to correspond to the spatial coordinates of the third focal point path P₃.

As it can be understood, in the example described with reference to FIGS. 2 to 4B, the spatial coordinates of the surface S are determined in successive iterations of the method. However, it can be understood that fewer or more iterations can be required in other embodiments. These iterations, which generally include moving the focal point 20 along a focal point path Pᵢ while imaging the resulting moving spot and updating the previous focal point path Pᵢ, can be performed many times per seconds, or less, depending on the embodiment. It is also understood that in some embodiments, the surface S is mobile relative to a fixed laser processing system 10. In some other embodiments, the surface S can be fixed and the laser processing system 10 can be mobile relative to the surface S. It is also understood that since the laser processing system 10 is mobile relative to the surface S, the surfaces irregularities are changing in time in terms of location, distance and peak-to-valley values.

It is noted that, in some embodiments, initial or current spatial coordinates of the surface S can be updated after, and even during, each pass of the laser processing beam 18.

For instance, with reference to the embodiments shown in FIGS. 2A, 3A, and 4A, initial spatial coordinates of the surface S can initially correspond to the first focal point path P₁, which can then be updated to correspond to the second focal point path P₂ after the second pass of the laser processing beam 18, and then to the third focal point path P₃ after the third pass of the laser processing beam 18, and so forth.

In this embodiment, the step of determining the current spatial coordinates of the surface S can be independent and simultaneous to the step of laser-processing the surface S. For instance, all the while the surface S is being illuminated by the laser processing beam 18, and imaged by the camera 16 to then determine the current spatial coordinates of the surface S, the laser processing subsystem 14 can be in the process of laser-processing the surface S based on previous, independent spatial coordinates of the surface.

In embodiments where the camera 16 acquires multiple images of the moving spot during a single pass of the laser processing beam 18 on the surface S, the laser processing system 10 can be configured to determine partial spatial coordinates of portions of the surface S as the laser processing beam 18 is gradually passed onto the surface S. In these embodiments, the current spatial coordinates of portions of the surface S can be updated in real time so that they reflect the partial spatial coordinates of the portions of the surface S where the laser processing beam has just passed. As such, only a portion of the current spatial coordinates may be updated.

It is envisaged that newly updated spatial coordinates of the surface S can be stored on a memory system which the laser processing subsystem 14 may directly or indirectly access to retrieve the latest spatial coordinates of the surface S. It is noted that a first computation step, in which the computer 22 updates the spatial coordinates of the surface S, can be independent from a second computation step, in which the computer 22 determines the spatial coordinates of the subsequent pass of the laser processing beam 18. In such embodiments, both the first and second computation steps can have access to the current spatial coordinates stored on the memory system as desired. Both computation steps can be performed at different frequencies.

As can be understood, during said imaging, the focal point 20 can have an intensity I exceeding a laser processing threshold Iₜₕᵣₑₛ. Depending on the embodiment, the laser processing threshold Iₜₕᵣₑₛ can be a laser-cleaning threshold, a laser marking threshold or a laser cutting threshold. Accordingly, during said imaging, the laser processing beam 18 can be used to laser process, e.g., laser clean, laser mark or laser cut, the surface S during the successive passes of the focal point 20. Of course, the wavelength of the laser processing beam 18 can be chosen based on the desired type of laser-processing and on the material to be laser-processed. For instance, it is known that laser cleaning of stainless steel or aluminum can be done with a laser beam having a center wavelength of 1064 nm, and plastics, composites and organic materials are more easily processed with laser beam having wavelength around 10.64 microns).

In one mode of operation, the focal point 20 of the laser processing beam 18 has an intensity I exceeding the laser processing threshold Iₜₕᵣₑₛ during said imaging, so that it can be determined that the surface S is satisfactorily laser-processed based on the features of the imaged spot. For instance, from image 36 of FIG. 2B, it can be determined that none of the surface S has been satisfactorily laser processed in the first pass of the focal point 20 along the first focal point path P₁. However, from image 40 of FIG. 3B, it can be determined that the surface S has been satisfactorily laser-processed in the two spaced apart portions 42 and 44 in the second pass of the focal point 20 along the second focal point path P₂, leaving the middle portion 46 either unsatisfactorily laser-processed or not laser processed at all. Finally, from image 50 of FIG. 4B, it can be determined that the surface S has been satisfactorily laser-processed in the middle portion 48 of the third focal point path P₃.

In alternate embodiments, the third focal point path P₃ could have been determined as consisting only of the middle portion 48, as the second pass of the focal point 20 along the spaced apart portions 42 and 44 of the second focal point path P₂ would already had yielded satisfactory laser-processing.

In one other mode of operation, the focal point 20 of the laser processing beam 18 has an intensity I below the laser processing threshold Iₜₕᵣₑₛ during said imaging, so that the spatial coordinates of the surface S can be determined while not necessarily laser-processing the surface S during said imaging. Then, the intensity I of the focal point 20 of the laser processing beam 18 can be increased above the laser processing threshold Iₜₕᵣₑₛ to actually laser-process the surface S based on the previously determined spatial coordinates of the surface S, for instance, in only one pass of the focal spot 20.

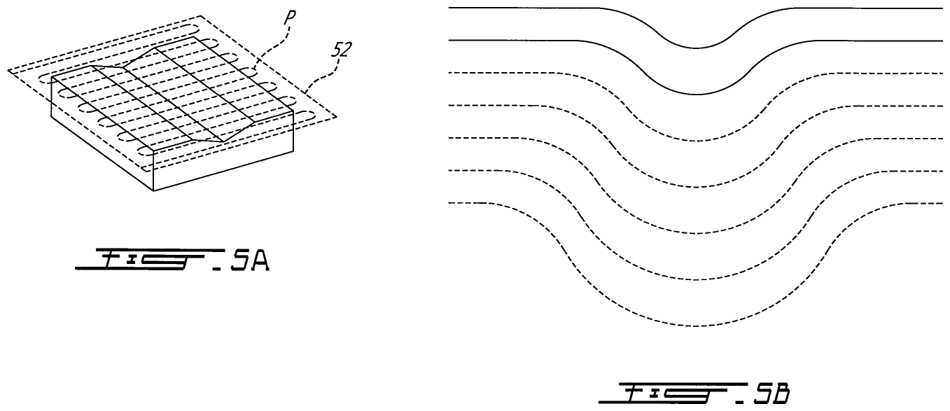

FIG. 5A shows an oblique view of the surface S, with a focal point path P mapping a laser processing window 52, in which the surface S to laser process is positioned. The laser processing window 52 can correspond to a field of operation of the laser processing subsystem 14. The focal point path P can be continuous so as to be scanned by the focal point 20 in the laser processing window 52. In alternate embodiments, however, the focal point path P mapping the laser processing window 52 includes a plurality of focal point paths Pᵢ spaced apart from one another. In these embodiments, illumination of the surface S resulting from the movement of the focal point along the focal point path(s) mapping the laser processing window 32 can be imaged throughout a series of images, as shown in FIG. 5B. Based on the method described above, the coordinates of the surface S in the laser processing window 52 can be determined from the series of images, which can help to update the focal point path Pᵢ until it corresponds to the surface S to laser process.

In some embodiments, the laser processing system 10 can be configured to control the type of laser-processing that is performed by the laser processing beam 18 depending on previously determined spatial coordinates of the surface S. More specifically, the intensity of the focal point 20 can be increased above the laser processing threshold Iₜₕᵣₑₛ only when the focal point 20 is directed at a predetermined spatial regions of the surface S. For instance, the intensity of the focal point 20 can be increased above the laser processing threshold Iₜₕᵣₑₛ when it is determined that the surface S is at a given depth, or within a predetermined depth range. The intensity of the focal point 20 can be decreased below the laser processing threshold Iₜₕᵣₑₛ upon determining that the surface S lies within a given non-laser processing zone in some alternate embodiments.

As can be understood, the examples described above and illustrated are intended to be exemplary only. For instance, the frame can be fixed relative to the ground in some other embodiments. Alternately, the frame can include a first frame to which is mounted the laser processing subsystem and a second frame to which is mounted the camera, where the first frame and the second frame are made integral to one another. In another example, the camera and the laser processing subsystem could be mounted on independent frames that are mechanically referenced one to the other by mean of position captors, referenced actuators or any other means. As can be understood, the expression “calibration data” is meant to be construed broadly so as to encompass data stored in the form of table, array, or even in the form of mathematical relations. The laser processing system can have any type of suitable configuration allowing triangulation of the surface. For instance, the laser processing system can have a standard configuration in which the laser processing beam is perpendicular to the surface and the camera images the surface from an oblique perspective; a reverse configuration in which the laser processing beam is oblique relative to the surface and the camera images the surface from a perpendicular perspective; a specular configuration in which the laser processing beam and the field of view of the camera are oblique relative to the surface, and in which they points towards a same direction; and a look-away configuration in which the laser processing beam and the field of view of the camera are oblique relative to the surface, and in which they point in opposite directions. However, any other suitable configuration can be used. In some embodiments, the first pass of the laser processing beam can be performed based on initial coordinates of the surface to be laser-processed. However, in some embodiments, particularly in embodiments where initial coordinates of the surface are unknown, the first pass of the laser processing beam on the surface S can be performed based on default spatial coordinates, which may correspond to a default focal point path of the focal point of the laser processing beam. For instance, in some embodiments, the default focal point path can be set to extend in a plane spaced-apart by a predetermined spacing (e.g., 30 cm) from the frame of the laser processing system. The scope is indicated by the appended claims.

1. A method for laser-processing a surface, the method comprising:
directing, from a first viewpoint, a laser processing beam towards said surface including providing a focal point of said laser processing beam at a focal point position, resulting in illuminating said surface with a spot, while imaging said spot on said surface from a second viewpoint different from the first viewpoint;
determining spatial coordinates of said surface based on calibration data and a feature of said imaged spot; and
laser-processing said surface based on said previously determined spatial coordinates of said surface.

2. The method of claim 1 wherein said feature is provided in the form of a center position of said imaged spot.

3. The method of claim 1 wherein said feature is provided in the form of a dimension of said imaged spot.

4. The method of claim 1 wherein said directing includes moving said focal point of said laser processing beam along a focal point path, resulting in illuminating said surface with a moving spot, said imaging including imaging said moving spot on said surface.

5. The method of claim 4 wherein said feature is provided in the form of a center path of said imaged moving spot.

6. The method of claim 4 wherein said feature is provided in the form a dimension of said imaged moving spot, said dimension being perpendicular to a direction of movement of the focal point.

7. The method of claim 4 wherein the focal point path includes a plurality of focal point paths mapping a laser processing window, the method further comprising performing, for the plurality of focal point paths, said directing, said imaging, said determining and said laser-processing until said surface in said laser processing window is laser-processed.

8. The method of claim 1 wherein, during said imaging, said focal point has an intensity exceeding a laser processing threshold.

9. The method of claim 1 wherein said directing is performed based on initial spatial coordinates of said surface, the method further comprising updating said initial spatial coordinates based on the determined spatial coordinates of said surface.

10. The method of claim 9 wherein said laser-processing is independent and simultaneous to said determining.

11. A laser processing system comprising:
a frame;
a laser processing subsystem mounted to said frame and having a first viewpoint relative to a surface, the laser processing subsystem being adapted to direct a laser processing beam towards said surface and to provide a focal point of said laser processing beam at a focal point position, resulting in illuminating said surface with a spot;
a camera mounted to said frame and having a second viewpoint different from said first viewpoint, the camera being adapted to, simultaneously to said illuminating, image said spot of said surface and to generate an image of said spot;
a computer communicatively coupled to said laser processing subsystem and to said camera, said computer having a memory system having stored thereon instructions executable by a processor to:
determine spatial coordinates of said surface based on calibration data and a feature of said imaged spot in said image; and
instruct the laser processing subsystem to laser process said surface based on said previously determined spatial coordinates of said surface.

12. The laser processing system of claim 11 wherein the frame has one or more handles protruding from the frame.

13. The laser processing system of claim 11 wherein the laser processing beam has a wavelength in an infrared region of the electromagnetic spectrum, the camera being configured to image illumination in said infrared region of the electromagnetic spectrum.

14. The laser processing system of claim 11 wherein said feature is provided in the form of a center position of said imaged spot.

15. The laser processing system of claim 11 wherein said feature is provided in the form of a dimension of said imaged spot.

16. The laser processing system of claim 11 wherein said directing includes moving said focal point of said laser processing beam along a focal point path, resulting in illuminating said surface with a moving spot, said imaging including imaging said moving spot on said surface.

17. The laser processing system of claim 16 wherein said feature is provided in the form of a center path of said imaged moving spot.

18. The laser processing system of claim 16 wherein said feature is provided in the form of a dimension of said imaged moving spot, said dimension being perpendicular to a direction of movement of the focal point.

19. A method for determining spatial coordinates of a surface, the method comprising:
directing, from a first viewpoint, a laser processing beam towards said surface including providing a focal point of said laser processing beam at a focal point position, resulting in illuminating said surface with a spot, while imaging said spot on said surface from a second viewpoint different from the first viewpoint; and
determining spatial coordinates of said surface based on calibration data and a feature of said imaged spot.

20-21. (canceled)

22. The method of claim 19 wherein said directing is performed based on initial spatial coordinates of said surface, the method further comprising updating said initial spatial coordinates based on the determined spatial coordinates of said surface.

23. (canceled)
